(19) United States
(12) Patent Application Publication
(10) Pub. No.: US 2021/0089639 A1
(43) Pub. Date: Mar. 25, 2021

(54) METHOD AND SYSTEM FOR 3D GRAPHICAL AUTHENTICATION ON ELECTRONIC DEVICES

(71) Applicant: OneVisage SA, Lausanne (CH)

(72) Inventors: Christophe REMILLET, Lausanne (CH); Clemens BLUMER, Bâle (CH)

(21) Appl. No.: 16/965,931

(22) PCT Filed: Jan. 30, 2019
(86) PCT No.: PCT/IB2019/050736

§ 371 Date: Jul. 29, 2020

Related U.S. Application Data
(63) Continuation-in-part of application No. 15/921,235, filed on Mar. 14, 2018, now abandoned.

(30) Foreign Application Priority Data
Jan. 30, 2018 (EP) 18154061.8

(51) Int. Cl. G06F 21/36; G06F 21/32; G06F 21/46; G06F 3/0481

(52) U.S. Cl. CPC G06F 21/36; G06F 21/32; G06K 9/00288; G06F 3/04815; G06F 21/46

(57) ABSTRACT

The invention concerns a three-dimensional graphical authentication method for verifying the identity of a user through an electronic device having a graphical display, comprising the steps of: —receiving an authentication request, —displaying a three-dimensional virtual world containing a plurality of virtual objects by using scene graph with geometry instancing and low poly graphics, —navigating in the three-dimensional virtual world by using a rotatable and scalable scene view, —selecting one or plural virtual object(s) and/or performing one or plural pre-defined virtual object action(s)s to form a 3D password made of unique identifiers that correspond to the pre-defined virtual objects and/or actions in the scene graph, —determining if the formed 3D password matches a 3D password defined at a previous enrolment phase; and—granting the resource access to the user in case of 3D password matching or rejecting the resource access to the user in case of matching failure.

### FIELD OF THE INVENTION

The invention relates to a method and a system that verifies the identity of a user in possession of an electronic device by asking her a secret that is made of one or a plurality of virtual objects or augmented reality objects displayed in one or a plurality of virtual worlds or sub-worlds. The invention also unveils a possible concurrent multi-factor approach that comprises further one or several biometric authentication phase(s) and mainly discloses a new method and system to provide higher digital entropy.

### DESCRIPTION OF RELATED ART

Nowadays, user authentication has become a key challenge for any digital services providers. Different authentication mechanisms and solutions have emerged, relying on one or plural authentication factors (MFA), a factor of authentication being something you know, something you have or something you are.

The concept of graphical passwords has been introduced twenty years ago (Greg E. Blonder, Graphical password, patent U.S. Pat. No. 5,559,961, September 1996) and three-dimensional graphical authentication using virtual objects in virtual environments is currently state-of-the art for recognition-based methods.

Referring to paper “Three-dimensional password for more secure authentication”, issued to Fawaz A. Alsulaiman et Al., IEEE Vol. 57, N^{o} 9, September 2008, the publication discloses some of the key concepts used in 3D graphical authentication. More particularly, it discloses design guidelines concerning real-life similarity, object uniqueness and distinction, size of the 3D virtual world, the number of objects and their types and the system importance (what needs to be protected). However, the paper doesn't disclose any methods and techniques to address these guidelines, particularly when it comes to smartphones with limited resources and computation power.

Referring to paper, “Passaction: a new user authentication strategy based on 3D virtual environment”, issued to Prasseda K. Gopinadhan, IJCSITS Vol. 2, N^{o}. 2, April 2012, the publication discloses a possible embodiment of paper “Three-dimensional password for more secure authentication” Fawaz A. Alsulaiman et Al., where the user has to perform an action on one or a plurality of objects. The system and method proposed contains a password creation stage requiring the selection of a virtual environment from a gallery on a server, which creation results in the creation of linked list containing the “passaction” nodes, the password storage stage and the authentication stage. However, like paper “Three-dimensional password for more secure authentication” Fawaz A. Alsulaiman et Al.”, the scientific paper “Passaction” doesn't disclose a method and system to manage thousands or more of virtual objects in the 3D virtual world, how to provide efficient object selection and distinction.

Referring to paper “Network Security—Overcome password hacking through graphical password authentication”, issued to P. Kiruthika et al., IJARCSA, Vol. 2, Issue 4, April 2014, the paper summarizes shoulder-surfing methods and their inconveniences and discloses a new technique for graphical authentication based on displaying an image frame containing greyed pictures or symbols, the selection of one or a plurality of grey images constituting the graphical password. However, the scientific paper doesn't disclose a method and system to manage thousands or more of virtual objects in the 3D virtual world, how to use few images while maintaining the digital entropy very high.

Referring to paper “Leveraging 3D Benefits for Authentication”, issued to Jonathan Gugary et al., IJNC, 2017, 10, 324-338, the paper unveils some of the key concepts used in graphical authentication and discloses a new authentication method based on the use of spatial memory, episodic memory and context, where the user needs to navigate into a virtual world and perform actions on virtual objects. The set of performed actions and the navigation paths used constitute the user secret. However, the scientific paper doesn't disclose a method and system to manage thousands or more of virtual objects in the 3D virtual world, particularly when it comes to smartphones with limited resources and computation power, while providing a high digital entropy.

Patent WO 2017/218567, “Security approaches for virtual reality transactions”, issued to Vishal Anand et al. This patent illustrates an authentication method for a user to perform a secure payment transaction in a virtual environment, by performing a partial biometric authentication.

Patent US 2017/0262855, “System and Method for Authentication and Payment in a Virtual Reality Environment”, issued to Vijn Venugopalan et al. This patent illustrates a system and method that authenticates the user via a biometric sensor, allowing the user to access a digital wallet displayed in the virtual environment.

Patent EP3163402, “Method for authenticating an HMD user by radial menu”, issued to Vui Huang Tea, this patent illustrates a method for authenticating a user that comprises the mounting of a virtual reality device on the head of the user, the display of steady images containing selectable elements with the virtual reality that can be selected by pointing the head towards the location of one of the selectable elements. This patent presents a password-selection method through head pointing in a virtual reality device.

Patent U.S. Pat. No. 8,854,178, “Enabling authentication and/or effectuating events in virtual environments based on shaking patterns and/or environmental information associated with real-world handheld devices”, issued to Thomas Gross et al. This patent illustrates an authentication method based on shaking a pair of handheld devices.

Patent WO-2014013252, “Pin verification”, issued to Justin Pike. This patent illustrates an authentication method based on pin-code entry, where the pin pad may use numbers mixed with images.

Patent US-20130198861, “Virtual avatar authentication”, issued to Gregory T. Kishi et al. This patent describes a method for a machine-controlled entity to be authenticated by analysing a set of challenges-responses to get access to a resource.

Patent CN-106203410, “Authentication method and system”, issued to Zhong Huaigu et al. This patent illustrates a biometric authentication method based on capturing two images of an iris and performing a match of the final iris image to authenticate the user.

Patent U.S. Pat. No. 8,424,065, “Apparatus and method of identity and virtual object management and sharing among virtual worlds”, issued to Boas Betzler et al, this patent illustrates a system and method to centrally manage credential information and virtual properties across a plurality of virtual worlds.

Patent US-2015/0248547, “Graphical authentication”, issued to Martin Philip Riddiford. This patent illustrates an authentication method that displays a first base image containing one or multiple points of interests selected by the user, a second transparent or translucent image overlaying the base image containing an array of password elements such as words, numbers, letters, icons and so forth and where the user can move the secondary image to align one password element with the point of interest displayed on the base image.

Patent US-2017/0372056, “Visual data processing of response images for authentication”, issued to Srivathsan Narasimhan, this patent illustrates an authentication method where user must mimic facial expressions shown on at least two images.

Patent US-2009/0046929, “Image-based code”, issued to David De Leon. This patent illustrates an authentication method that requires one or a plurality of instructions to construct a first unified image made of sub-images. The method mainly proposes to add additional layered images or characters on top of the first unified image to authenticate the user. The method can be particularly complex and tedious as it requires plural instructions to build the first unified image to increase security.

Patent CN-107358074A, “Unlock method and virtual reality devices” issued to Wand Le. This patent illustrates a method to unlock a virtual reality device by selecting one or a plurality of virtual objects in the virtual environment.

Patent CN-104991712A, “Unlocking method based on mobile terminal and mobile terminal”, issued to Xie Fang. This patent illustrates an authentication method that requires the user to slide the touch-screen, where the slide operation should unlock points on a rotatable 3D figure.

Patent US-2016/0188865, “3D Pass-Go”, issued to Hai Tao. This patent illustrates a method that displays a grid in a 3D space and requires the user to select one or more intersections to compose or form the user's password.

Patent US-2016/188861, “User authentication system and method”, issued to Erik Todeschini. This patent illustrates a method and system for authenticating a user that comprises the mounting of a virtual reality device on the head of the user, analysis of the user's gestures to change the form of a 3D shape displayed in the virtual reality device.

Patent EP-2887253, “User authentication via graphical augmented reality password”, issued to Mike Scavezze, this patent illustrates a method and system for authenticating a user that comprises the mounting of a virtual reality device on the head of the user and the analysis of the user's movements in a predefined order made at enrolment.

Patent KR-101499350B, “System and method for decoding password using 3D gesture recognition”, issued to Kim Dong Juet al. This patent illustrates a method that authenticates the user by analysing the user's gesture

Patent US-2016/0055330A1, “Three-dimensional unlocking device, three-dimensional unlocking method and program”, issued to Koji Morishita et al., This patent illustrates an authentication method based on 3D lock data representing multiple virtual objects that have been arbitrarily arranged in the 3D space and where user needs to perform a selection operation on the virtual objects, in the right order, to get authenticated.

Patent US-2014/0189819, “3D Cloud Lock”, issued to Jean-Jacques Grimaud. This patent illustrates an authentication method that project objects in 3D in a randomized way in a fixed scene, where the user needs to manipulate the position of the objects, to retrieve the original objects and their respective positions as defined at enrolment. The method requires to modify the randomized presentation of the objects in a fixed scene and to manipulate the object positions to retrieve the exact objects and positions to undo or solve the randomization.

Patent WO-2013/153099A1, “Method and system for managing password”, issued to Pierre Girard et al. This patent illustrates a simple password retrieval mechanism by asking the user to select a first picture in the virtual world, then select a second picture, where the matching of the first and second pictures allows to extract the secret password associated with the first picture and communicate it to the user.

There exist a need to propose an authentication method and system that overcome at least some of the drawbacks of the existing authentication methods and systems

There exist a need to propose an improved authentication method and system with respect of the existing authentication methods and systems.

Therefore, in view of existing systems, there is a need to propose an authentication method and system that provides higher, preferably very high digital entropy, while maintaining a great user-experience.

### BRIEF SUMMARY OF THE INVENTION

The invention concerns a method and a system for graphically authenticating a user, the user selecting and/or performing meaningful actions on one or plural virtual objects or augmented reality objects contained in a three-dimensional virtual world.

In one preferred embodiment, there is provided a 3D graphical authentication method and system that mainly comprises, an authentication application performed on an electronic device, the display of a 3D virtual world containing virtual objects or augmented reality objects, the selection or action of one or a plurality of virtual objects, which selections and/or actions define the user secret formed by a 3D password; namely those selections and/or actions constitute the entering of the password.

In another preferred embodiment, the method and system can comprise further one or a plurality of biometric authentication modalities such as 3D facial authentication, iris authentication, in-display fingerprint authentication, palm-vein authentication or behavioral authentication that are being performed simultaneously and concurrently to the 3D graphical authentication. For example, if the user owns a smartphone capable of 3D facial authentication like Face ID by Apple (registered Trademark), the method can perform concurrent 3D facial biometric authentication while the user is selecting the virtual objects corresponding to her secret.

Some embodiments of the invention particularly addresses unresolved issues in 3D graphical authentication prior art, comprising user-experience personalization, virtual world size and navigability, recall-memory improvement, digital entropy improvement and shoulder-surfing resilience.

According to an embodiment of the invention, is proposed a three-dimensional graphical authentication method for verifying the identity of a user through an electronic device having a graphical display, comprising the steps of:
receiving an authentication request or launching an application,
displaying a three-dimensional virtual world containing a plurality of virtual alleviated objects or augmented reality objects by using scene graph, each alleviated object using a reduced number of meshes and customized textures in a way that it represents a meaningful atomic object and pattern that can be reused many times through geometry instancing,
navigating in the three-dimensional virtual world by using a rotatable and scalable scene view,
selecting one or plural virtual alleviated objects and/or performing pre-defined virtual object actions to form a 3D password, the 3D password being made of unique identifiers that correspond to the pre-defined virtual objects and/or actions in the scene graph,
determining if the formed 3D password matches a 3D password defined at a previous enrolment phase; and
granting the resource access to the user in case of 3D password matching or rejecting the resource access to the user in case of matching failure.

According to an embodiment, the user can navigate in the said three-dimensional virtual world by using 3D context sensitive teleportation, the teleportation destinations being context sensitive on the current scene view and scale.

According to an embodiment, the said teleportation destination can be a pre-defined position or destination in the selected virtual world or alternatively in another virtual world.

According to an embodiment, each selected virtual object or sub-part of the selected virtual object teleports the user in a local scene representing the selected virtual object or sub-part of the selected virtual object, or in a local scene with an inside view of the selected virtual object. In an embodiment, the application proposes a list of teleportation destination shortcuts.

According to an embodiment, the three-dimensional scene voids the user to navigate directly through virtual objects, and/or void navigating under the 3D virtual world by displaying negative scene angles for real-life similarity purposes.

According to an embodiment, during said selection step, the user performs 3D contextual object selection, comprising using a pointing cursor, displayed or not in the scene, that allows to select virtual objects which are at three-dimensional radar distance of the said pointing cursor. The pointing cursor has preferably a small three-dimensional size of a few pixels to perform accurate object selection.

According to an embodiment, the selection step comprises any well-known selection techniques including but not limited to, single tapping, double tapping, clicking, voice-enabled command or device shaking.

According to an embodiment, during said selection step, said pointing cursor is moved in the scene view or is placed onto a teleportation destination marker or on a virtual object that offers teleporting capabilities to navigate in the virtual world or get teleported to the selected destination.

According to other possible aspects of the invention, to be taken alone or in combination:
said pointing cursor can display a contextual box that shortly describes the virtual object, the description preferably not unveiling the unique identifier of the said virtual object,
said contextual box can be used to select the virtual object
said pointing cursor can display plural contextual boxes in case of multiple possible virtual object selections that are at a three-dimensional radar distance of the said pointing cursor.

According to an embodiment, during said selection step the user applies a pre-defined action on a virtual object, said virtual object action representing said 3D password or part of said 3D password.

According to an embodiment, said virtual object action is selected into a displayed list of possible actions into a contextual window. In another alternative, said virtual object action is selected into a separate window or said virtual object action teleports the user in a local scene representing said selected virtual object or sub-part of the selected virtual object, or in a local scene with an inside view of the selected virtual object.

According to an embodiment, said virtual object action is dynamic, requiring the user to take into account one or several dynamic criteria to specify or to define said virtual object action.

According to an embodiment, wherein when performing the selection step, one or several visual, audio and/or haptic effect is further performed comprising but not limited to, displaying a blurred area/contour, displaying a colored contour around the object, displaying a small animation, playing an audio message or vibrating the device.

According to an embodiment, said 3D password matching determination step is performed by using one or a plurality of unique identifiers corresponding to the virtual objects and/or actions performed on these objects, the matching being performed by comparing identifiers used at enrolment and at authentication.

According to an embodiment, previous to the step of displaying a three-dimensional virtual world, a plurality of selectable virtual worlds is first proposed to the user who makes a selection of one three-dimensional virtual world among these selectable three-dimensional virtual worlds. For instance, the plurality of selectable virtual worlds corresponds to a list of at least three three-dimensional virtual worlds, or of at least five three-dimensional virtual worlds or of at least ten three-dimensional virtual worlds. This allows to increase the global digital entropy and offers higher user personalization and areas of interest that provides higher memory-recall.

The invention also concerns a context sensitive authentication method that comprises the 3D graphical authentication method defined in the text, wherein said context sensitive authentication method dynamically determines the level of security required to get authentication accordingly to the nature of the transaction, the security level being represented graphically on the display of the electronic device and indicating to the user how many virtual objects or virtual objects actions are required during the selection step and also possibly during the enrolment phase.

According to an embodiment, during the selection step, a selection order is attached to each selected virtual object and each virtual object action. In a possible embodiment, during the selection step, security icons are displayed, that the user can select and drag onto the virtual object to prior indicate a selection order.

According to an embodiment, wherein said method further comprises an emergency or assistance signalling procedure that comprises the selection of at least one 911 virtual object and/or the implementation of at least one pre-defined emergency action on a virtual object, said procedure being performed at any time during the selection step or the 3D password selection step or the or the 3D password entering step.

The present invention also concerns in a possible embodiment, a multi-factor authentication method that comprises the 3D graphical authentication method defined in the present text and one or several biometric authentication control(s), each biometric authentication control being performed concurrently to said 3D graphical authentication method. This approach allows to drastically increase the digital entropy or global password space.

According to an embodiment, the multi-factor authentication method for verifying the identity of a user, comprises the steps of:
providing an electronic device, said electronic device having a graphical display and a sensor,
receiving an authentication request starting an authentication phase during which are simultaneously implemented in parallel a three-dimensional graphical authentication method and a biometric authentication method, wherein
said three-dimensional graphical authentication method comprises the following steps:
   displaying a three-dimensional virtual world containing a plurality from virtual objects and augmented reality objects by using scene graph with geometry instancing and low poly graphics;
   navigating in the three-dimensional virtual world by using a rotatable and scalable scene view on said display;
   selecting at least one operation from selecting one or a plurality of virtual objects and performing one or a plurality of virtual object actions, forming thereby a first formed 3D password made of unique identifiers that comprise at least one from selected virtual object(s) and performed action(s) in the scene graph;
   comparing said first formed 3D password to a first pre-defined 3D password; and
   providing a first 3D password comparison result;
said biometric authentication method comprises the following steps:
   capturing a representation of a biometric attribute of the user through said sensor,
   comparing said captured representation of said biometric attribute to a recorded representation of said biometric attribute; and
   providing a biometric comparison result;
said first 3D password comparison result and said biometric comparison result being taken into account into a final authentication step including establishing a global authentication score.

According to a possible embodiment of this multi-factor authentication method, before receiving an authentication request, the method further comprises the step of implementing an enrolment phase, in which
said pre-defined 3D password is defined through a selection step comprising at least one operation from selection of at least one virtual object and performing at least one virtual object action in the scene graph, said selection step forming thereby said pre-defined 3D password made of unique identifiers, and
said recorded representation of said biometric attribute of the user is captured through a sensor and recorded in a memory.

The invention also concerns a dynamic context sensitive authentication method, including the multi-factor authentication method as described in the present text, wherein in case said global authentication score is lower than a pre-defined global security score, the three-dimensional graphical authentication method further comprises the following steps:
selecting at least one operation from selecting one or a plurality of virtual objects and performing one or a plurality of virtual object actions, forming thereby a second formed 3D password made of unique identifiers that comprise at least one from selected virtual object(s) and performed action(s) in the scene graph;
comparing said second formed 3D password to a pre-defined second 3D password; and
providing a second 3D password comparison result;
said first 3D password comparison result, second 3D password comparison result and said biometric comparison result being taken into account into a final authentication step including establishing a global authentication score.

The invention also concerns a dynamic context sensitive authentication method, including the multi-factor authentication method as described in the present text, wherein in case said global authentication score is lower than a pre-defined global security score, said biometric authentication method comprises the following steps:
capturing a first representation of a biometric attribute of the user through said sensor,
comparing said first captured representation of said biometric attribute to a recorded representation of said biometric attribute; and
providing a first biometric comparison result;
capturing a second representation of a biometric attribute of the user through said sensor,
comparing said second captured representation of said biometric attribute to a recorded representation of said biometric attribute; and
providing a second biometric comparison result;
said first 3D password comparison result, said first biometric comparison result and said second biometric comparison result being taken into account into a final authentication step including establishing a global authentication score.

The invention also concerns, in a possible embodiment, a dynamic context sensitive authentication method, including the multi-factor authentication method as described in the present text, wherein in case said global authentication score is lower than a pre-defined global security score, the method comprises implementing further at least one from a three-dimensional graphical authentication method and a biometric authentication method which provides a further comparison result, the global authentication score taking into account said further comparison result.

So according to the security threshold to perform a high-level transaction, the method can dynamically adapt the number of 3D graphical secrets to be entered (i.e. the number of implementations of the three-dimensional graphical authentication method defined in the text, namely one, two or more) and/or the number of biometric authentication checks (i.e. the number of implementations of the biometric authentication method defined in the text, namely one, two or more) until the global security score or global authentication score reaches the required the security threshold.

### BRIEF DESCRIPTION OF THE DRAWINGS

The invention will be better understood with the aid of the description of an embodiment given by way of example and illustrated by the figures, in which:

FIG. 1 is a schematic diagram of an electronic device such as a smartphone, tablet, personal computer or interactive terminal with a display,

FIG. 2 is a flow chart illustrating an exemplary method for authenticating the user according to a simple embodiment of the invention that uses only virtual world and items selection as authentication method,

FIG. 3 is a flow chart illustrating an exemplary method for authenticating the user according to another possible embodiment of the invention that uses both virtual world and items selection authentication and one or a plurality of biometric authentication as authentication method,

FIG. 4 illustrates an exemplary screenshot of 3D graphical authentication where the application displays a list of selectable virtual worlds and an overview of the current world selected,

FIG. 5 illustrates an exemplary screenshot of 3D graphical authentication where the application displays a list of possible destination areas in one or plural virtual worlds,

FIG. 6 illustrates an exemplary screenshot of 3D graphical authentication where the application displays a medium-scaled view of a selected virtual world and a possible embodiment of the 3D context-sensitive teleportation technique,

FIG. 7 illustrates an exemplary screenshot of 3D graphical authentication where the application displays a highly-scaled view of a selected virtual world and a possible embodiment of the 3D contextual selection technique,

FIG. 8 illustrates an exemplary of an alleviated 3D object. FIG. 8a corresponds to a regular 3D representation of a window object made of twelve meshes, comprising window glasses, different window frames and three textures. In FIG. 8b, the window object has been alleviated and is made of only one rectangle mesh and one texture, which texture has been designed to mimic a 3D effect and visually imitate the window object in FIG. 8a.

FIG. 9 illustrates a building object that uses alleviated window patterns (as described in FIG. 8) and geometry instantiation to alleviate the building meshes. In that example, the building façade is made of only 24 window patterns, therefore 24 meshes, as opposed to the 288 meshes that would be required with a regular 3D modelling.

FIG. 10 illustrates a 3D local scene of a flat, here a living room and kitchen, where the user has teleported himself, offering tens of object selection or interaction possibilities.

FIG. 11 illustrates an exemplary screenshot of 3D graphical authentication where the application displays a possible embodiment of the dynamic context sensitive authentication technique,

FIG. 12 illustrates an exemplary screenshot of 3D graphical authentication where the application displays a possible teleported destination area or sub-world represented in a local scene view,

FIG. 13 illustrates an exemplary screenshot of 3D graphical authentication where the application displays a possible embodiment of the dynamic object interaction technique,

FIG. 14 illustrates a possible embodiment where 3D facial biometry and graphical authentications must be performed concurrently and where application requires the user to expose his/her face to start the whole authentication process, and

FIG. 15 illustrates a possible embodiment where 3D facial biometry and graphical authentications must be performed concurrently and where application requires to start 3D facial biometry authentication first.

### DETAILED DESCRIPTION OF POSSIBLE EMBODIMENTS OF THE INVENTION

The following description is made for the purpose of illustrating the general principles of the present invention and is not meant to limit the inventive concepts or techniques claimed herein. Preferred and general embodiments of the present disclosure will be described, by way of example only, with reference to the drawings.

In the present text, the expression “Virtual World” means a 3-D virtual environment containing several various objects or items with which the user can interact when navigating through this environment. The type of interaction varies from one item to another. The representation may assume very different forms but in particular two or three-dimensional graphic landscape. As an example, the virtual world is a scene with which a user can interact by using computer-controlled input-output devices. To that end, the virtual world may combine 2D or 3D graphics with a touch-display, pointing, text-based or voice message-based communication system.

These objects are virtual objects or augmented reality objects. Namely “virtual objects” concern a digital counterpart of a real entity, possibly augmented with the awareness of the context in which the physical object operates and then acquired the ability to enhance the data received by the real world objects with environmental information. Another definition of virtual object is given by a digital representation, semantically enriched, of a real world object (human or lifeless, static or mobile, solid or intangible), which is able to acquire, analyze and interpret information about its context, to augment the potentialities of the associated services. Also “augmented reality objects” or “augmented virtual object” also encompass the capability to autonomously and adaptively interact with the surrounding environment, in order to dynamically deploy applications for the benefit of humans, so as to improve their quality of life. When “augmented reality objects” are used, the virtual world forms a three dimensional (3D) artificial immersive space or place that simulate real-world spatial awareness in a virtually-rich persistent workflow. Virtual objects can be any object that we encounter in real life. Any obvious actions and interactions toward the real-life objects can be done in the virtual 3-D environment toward the virtual objects.

Also, in the present text, a “virtual object action” is any action on a virtual object that changes the data linked to this virtual object, such as position, size, colour, shape, orientation, . . . . In an embodiment, this virtual object action change the appearance of this virtual object on the display. In another embodiment, this virtual object action does not change or only slightly change the appearance of this virtual object on the display. In all cases, the information linked to the virtual object is changed after any virtual object action. For instance, a virtual object action can be opening or closing a door, turning on a radio, selecting a radio channel on the radio, displacing a character in the street, dialing a number on a keyboard, changing the colour of a flower, adding a fruit in a basket, choosing a date in a calendar, choosing a set of cloths in a wardrobe, ringing a bell, turning a street lamp (or any light) on (or off), and so on.

The combination and the sequence of specific actions toward the specific objects construct the user's 3-D password.

A “scene graph” is a graph structure generally forming a tree through a collection of nodes, used to organizing scene elements, and which provide an efficient way to perform culling and apply operators on the relevant scene objects, thereby optimizing the displaying performance.

The expression “geometry instancing” is in real-time computer graphics the practice of rendering multiple copies of the same mesh in a scene at once. In other words, given a scene that contains many objects that use the same geometry, you can draw many instances of that geometry at different orientations, sizes, colors, and so on with dramatically better performance by reducing the amount of data you need to supply to the renderer.

The expressions “low poly graphics” or “alleviated poly graphics” or “low poly meshes” or “alleviated poly meshes” is a polygon mesh in 3D computer graphics that has a relatively small number of polygons. These Polygons are used in computer graphics to compose images that are three-dimensional in appearance. Usually (but not always) triangular, polygons arise when an object's surface is modeled, vertices are selected, and the object is rendered in a wire frame model. Thus the establishment of polygons for the virtual objects, is a stage in computer animation. In this respect, for each virtual object, or instance, a polygon design is established with low poly graphics, namely a structure of the object (skeleton) and the texture of the object with a reduced number of polygons allowing for easy display on the screen of a mobile equipment such as a mobile phone. Also, this polygon design with low poly graphics allows a good rendering of the virtual object on the screen (looks like real), and at the same time makes easier object selection. As an example a recognizable coffee cup could comprise about 500 polygons for a high poly model (high poly graphic), and about a third to an half corresponding number of polygons in low poly graphics, namely about 250 polygons per frame.

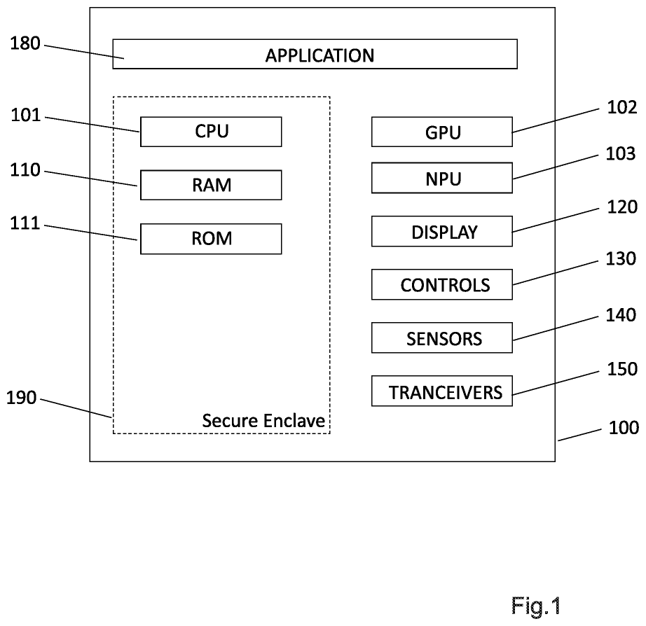

Referring to FIG. 1, there is shown an electronic device 100 such as a personal computer, smartphone, tablet computer, television, virtual reality device, interactive terminal or virtual reality device that includes one or plural central processor unit (“CPU”) 101, one or plural random access memory (“RAM”) 110, one or plural non-volatile memory (“ROM”) 111, one or plural display 120, one or plural user controls 130. Depending on the hardware characteristics of the electronic device 100, optional components can be available such as, but not limited to, one or plural graphical processor unit (“GPU”) 102, one or plural neural network processor (“NPU”) 103, one or plural sensors 140 such as, but not limited to, monochrome or RGB camera, depth camera, infra-red camera, in-display fingerprint sensor, iris sensor, retina sensor, proximity sensor, palm-vein sensor, finger-vein sensor, one or plural transceiver 150, a hardware security enclave 190, such as a Trusted Execution Environment (which can be associated to a Rich Execution Environment), that can protect the central processor unit 101, the random-access memory 110 and the non-volatile memory 111, which security enclave can be configured to protect any other optional hardware components mentioned before. This electronic device 100 can be a mobile equipment.

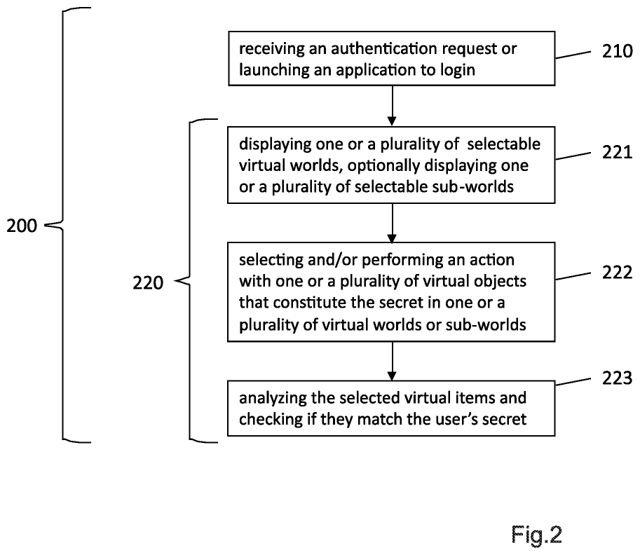

Referring to FIG. 2, there is illustrated a simple embodiment of the global authentication method 200. In a first step, an authentication event 210 is received by the application 180 being executed onto the electronic device 100. Upon receiving the authentication triggering event 210 (including an authentication request or the launching of an application login module, which application comprises the step of sending an authentication request), the application 180 starts the 3D graphical authentication 220 method. More precisely, during this 3D graphical authentication 220 method the following steps are implemented: the display of one or plural selectable virtual worlds or sub-worlds 221, the selection or interaction onto one or a plurality of virtual objects 222 contained in the virtual world, which virtual object or virtual objects and/or virtual object action(s) constitute the secret (3D password) defined by the user at enrolment, and the comparison 223 of the virtual object or virtual objects selected with the virtual item or virtual items that have been previously defined at user's enrolment.

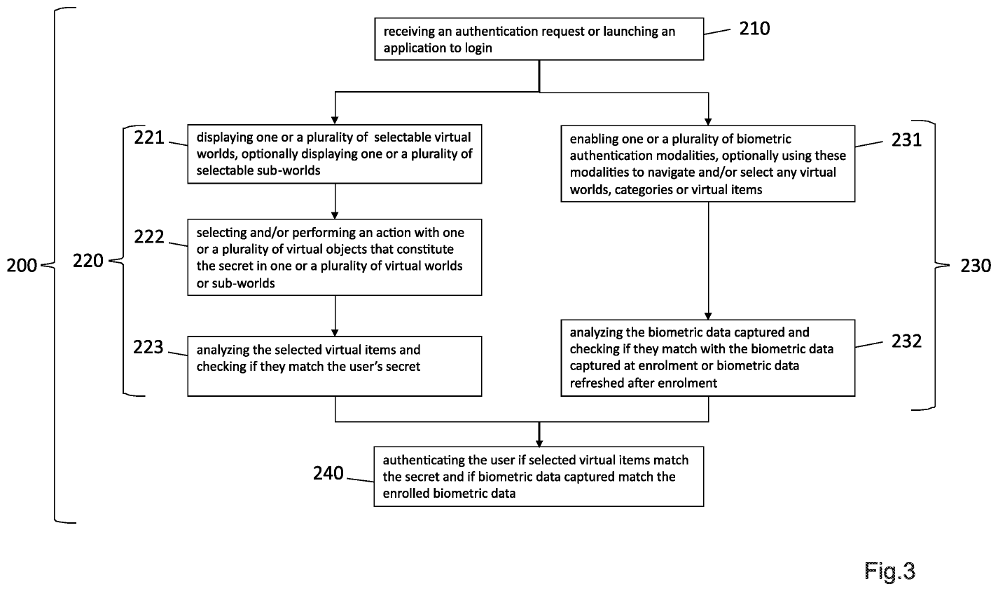

Referring to FIG. 3, there is shown another embodiment of the global authentication method 200 that comprises further one or several biometric authentication steps 230 performed in a concurrent way to the 3D graphical authentication 220. The biometric authentication method 230 can be launched immediately upon receiving the authentication request 210 or can be launched at any time during the 3D graphical authentication 220. In another embodiment, the biometric authentication method 230 is performed during the entirety of the 3D graphical authentication method 220 to increase the accuracy of the biometric authentication and/or collect more captured data to improve any machine learning algorithm. The biometric authentication method 230 comprises a step 231 during which one or several biometric authentication step(s) or control(s) are implemented and a step 232 during which the result of the biometric authentication(s) previously performed is then analyzed accordingly to defined scoring thresholds, such as false acceptance rate and/or false rejection rate. Upon the completion of the virtual world authentication method 220 and biometric authentication method 230 (activation phase 231 and matching phase 232), the system can determine a global authentication score, which can be used to determine if the user is authenticated or not. In that situation, after the implantation of both the biometric authentication method 230 and the 3D graphical authentication method 220, a final authentication step 240 is performed through a global authentication analysis module. This module and said final authentication step 240 do take into account both a 3D password comparison result and a biometric comparison result. Therefore, at the end of the final authentication step 240, the system defines a global authentication score which is compared to a pre-defined global security score. Depending on the difference between said pre-defined global security score and said global authentication score (through a comparison step). Finally, at the end of the final authentication step 240, the system gives a Yes or No reply to the question “is that current user of the electronic device the same as the registered user previously enrolled during the enrolment phase?”. In that method, before receiving an authentication request starting an authentication phase, an enrolment phase is implementing, with said electronic device or another electronic device comprising a graphical display and a sensor.

The method presented here is called “active background biometry” and should not be confused with sequential biometric authentication methods disclosed in the prior art, where biometric authentication is performed once, upon a specific user action in the 3D virtual world or in a sequential way with other authentication modalities or processes. As an example, rreferring to paper “Three-dimensional password for more secure authentication”, issued to Fawaz A. Alsulaiman et Al., IEEE Vol. 57, N^{o} 9, September 2008, there is disclosed a sequential biometric authentication method that typically interacts with a virtual object contained in the 3D virtual world, the virtual object representing a biometric sensor such as a fingerprint reader.

The “active background biometry” method enables two key benefits:
First, the user-experience is improved as the biometric authentication method 230 is performed in background, concurrently to the 3D graphical authentication method 220 without requiring or by requiring very minimal interaction of the user.
Second, the approach significantly increases the global password space, therefore the digital entropy, as each concurrent biometric authentication method 230 that is concurrently enabled is directly impacting the global number of possible combinations. As an example, a fraudster might be immediately kicked out at the beginning of the 3D graphical authentication step 220 upon detecting the user is wrong, seriously reducing the possibilities of conducting spoofing attacks.

Referring to paper “Three-dimensional password for more secure authentication”, issued by Fawaz Alsulaiman et al, IEEE Vol. 57, N^{o} 9, September 2008, the 3D password space formula is modified as follows:

$$Π ( Lmax , G ) = g ( BA ) * {\sum }_{n = 1}^{n = Lmax} {( m + g ( AC ) )}^{n}$$

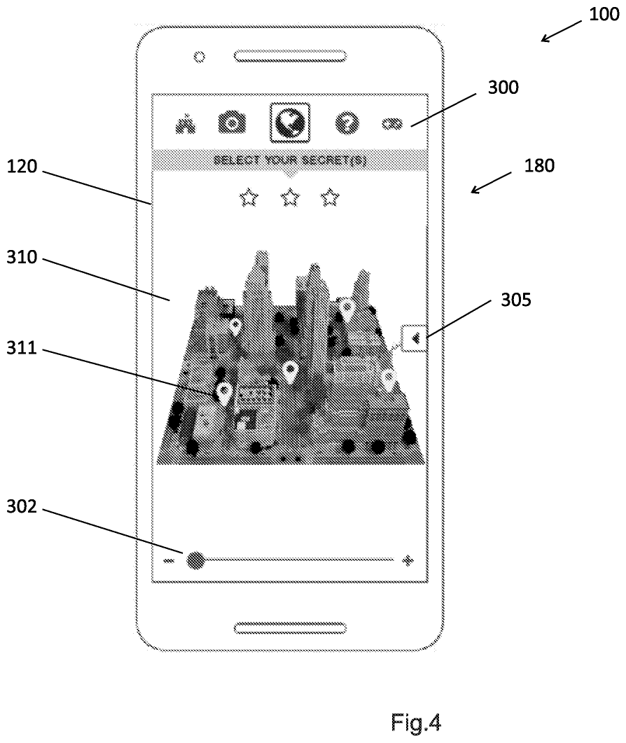

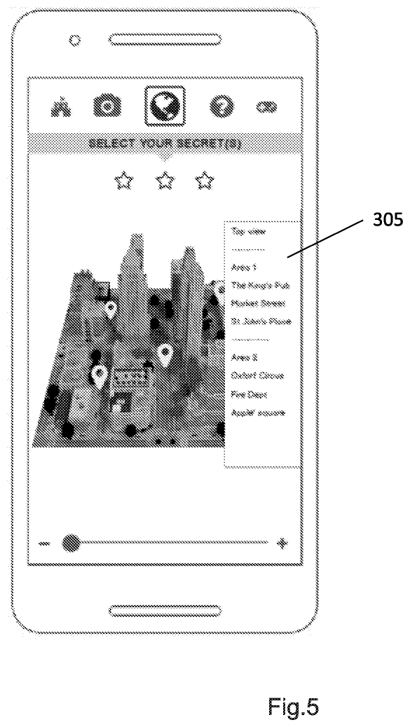

In the above expression, compared to the Fawaz Alsulaiman's formula, the g(BA) is a new factor and represents the total number of authentication combinations offered by the concurrent biometric modalities. As an example, if the total number of possible secret combinations offered by 3D graphical authentication is 1′000′000, and if the total number of biometric combinations is 100′000, then the global password space offered by the global method 200 will be 100′000′000′000. Referring to FIGS. 4 and 5, there is shown a possible embodiment that illustrates a virtual world based on a 3D virtual or reconstructed city, the authentication application 200 running on a regular smartphone forming the electronic device 100.

In one general preferred embodiment, the application 180 displays a list of selectable virtual worlds 300, the list 300 being formed of at least one virtual world that contains at least one secret selected by the user at enrolment and other virtual worlds. To increase security, the list of selectable virtual worlds 300 must always contain the same virtual worlds, excepted in case of secret's change by the user. The order of the virtual worlds in the list should be changed at each authentication to void spoofing applications recording user's movements or interactions and replaying sequences to trick the authentication application 180. Many possible graphical user interfaces can be implemented to manage the list of virtual worlds 300, including a variant where the user swipes the screen on left or right to move to another virtual world or a variant where all virtual worlds are displayed on the screen, using a thumbnail representation for each. Optionally, the application 180 can be extended to offer plural sub-world choices to increase the global password space.

Navigability

Referring to FIGS. 4 and 5, to provide a high navigability while displaying a rich virtual world made of many virtual objects, the application 180 displays a three-dimensional, rotatable and scalable virtual world 310. In a possible embodiment, particularly on touch-screen enabled devices 100, the scene view scale 302 can be changed by simply sliding the cursor with one finger, voiding the user to make a zoom with two fingers.

In a possible embodiment, the application 180 can limit the possible pitch values from 0 to 90 degrees, allowing the user's views to range from front-view to top-view, disabling possibilities for the user to navigate under the virtual world for real-life similarity purposes.

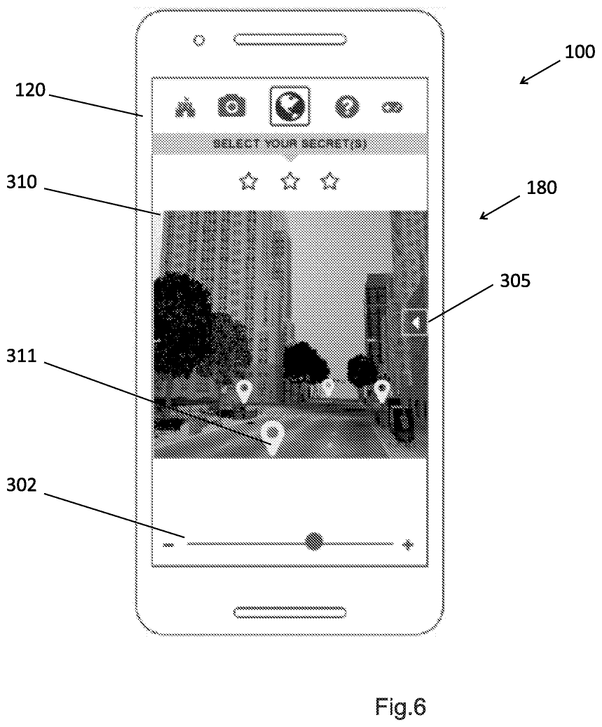

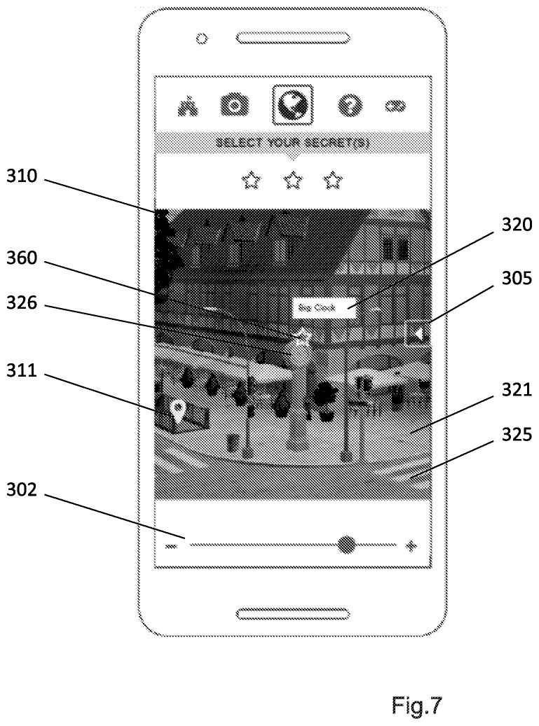

Referring to FIG. 4, the method proposes a novel concept called “3D context sensitive teleportation” to easily navigate in the virtual world 310 or optionally in other virtual worlds. In a default embodiment, the application 180 displays one or few context-sensitive teleport destinations 311. Depending on the teleport destination 311 selected by the user, the application 180 can change the global scene view, switch to a new local scene view, rotate the new virtual world, sub-world or object and make a zoom in or zoom out when moving to or when arriving at the selected destination. Contrarily to the current art, the novel concept of 3D context sensitive teleportation doesn't require to target an object by aligning a dot with the targeted object or to navigate through a specific path, as it is the virtual world itself that defines which objects and/or locations that can be used to teleport the user, depending on the context of the scene view and scale value applied to the virtual world. Referring to FIGS. 6 and 7, there are shown few possible examples that illustrate teleportation destinations 311.

It means that after selection by the user of the teleport destination 311 visible in FIG. 4 which forms an initial global scene view, showing herer a district of a town, by using therefor the pointing cursor 360,
in the example of FIG. 6, the new global scene view after teleportation is now a first street view from the middle of an avenue (the symbol of the teleport destination 311 is at the bottom of the screen on FIG. 6 showing the new global scene view after teleportation), with an enlarged scale with respect to the global scene view of FIG. 4 before teleportation (see scene view scale 302), and
in the example of FIG. 7, the new global scene view after teleportation is now a second street view from the corner between two streets (the symbol of the teleport destination 311 or teleportation marker, is at the bottom left of the screen on FIG. 7 showing the new global scene view after teleportation), with an enlarged scale with respect to the global scene view of FIG. 4 before teleportation (see scene view scale 302).

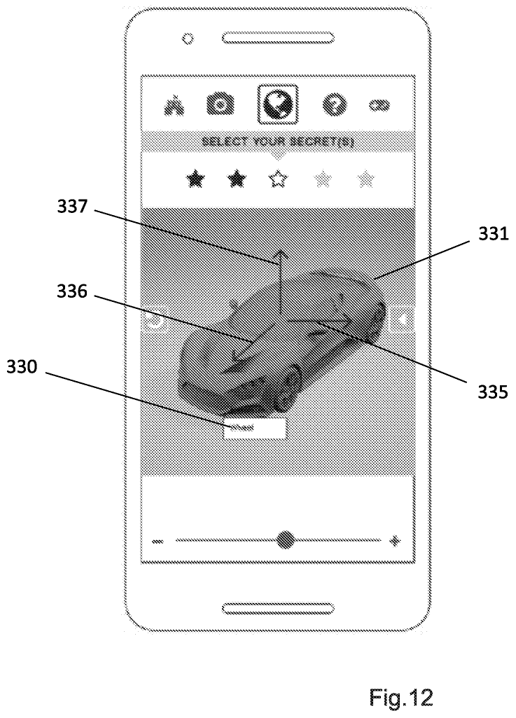

It means that after selection by the user of the teleport destination 311, the new global scene view of the teleportation destination has changed, including a change of content with respect to the initial global scene view and/or a change of scale with respect to the initial global scene view and/or a change of. Referring to FIG. 12, there is illustrated another aspect of the 3D context-sensitive teleportation concept where the destination, or new global scene view after teleportation, is a local scene representing a car 311.

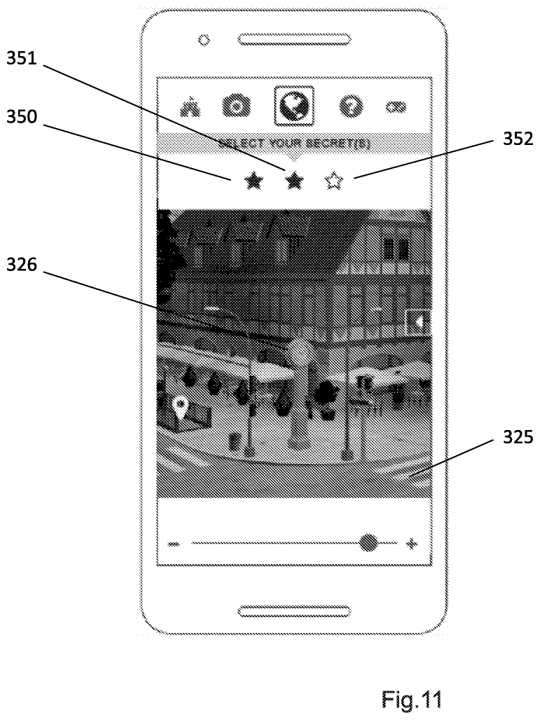

In that example, the user has tapped the teleportation marker of a car parked two blocks ahead of the pub displayed in FIG. 11. This example shows how powerful is the novel method as it allows by a single tap, screen touch, click or alike to teleport the user in another virtual world or sub-world. The number of teleportation possibilities is virtually infinite and each world or sub-world that the user can be teleported to increases the 3D password space. In that case, back to the Fawaz Alsulaiman's formula, it is the g(AC) parameter that is increased by summing all the virtual world password spaces. However, in a preferred embodiment, limiting the number of sub-levels to two is highly recommended for maintaining ease of use and keeping high memory recall.

Referring to FIG. 5, there is illustrated another preferred embodiment that displays destination areas shortcuts 305 (previously hidden in a tab 305 in FIG. 4), allowing the user to be teleported into pre-defined area of the current selected virtual world or other virtual worlds. For example, the user can select Market Street in area 1 of the current virtual world as the teleportation destination area. This mechanism prevents to display too many teleportation destination markers 311, particularly when it comes to large or very large virtual worlds.

Referring to FIG. 6, is shown another example of virtual world 310 displayed on the display 120 of the electronic device through the application 180. In that case, the virtual world 310 is a city after zooming on a street by activating the scene view scale 302. One can see several teleport destinations 311 visible through white markers, and also the tab for destination areas shortcuts 305 (on the left of the screen/display 120.

Selection of the Secret(s)

Referring to FIG. 7, there is illustrated a novel method called “3D contextual object selection” that allows to select a virtual object based on the 3D position of a pointing cursor 360 and the applied scale 302 in the scene view. The novel method disclosed here displays the contextual object box 320 of the virtual object 326 when the virtual object 326 is at a 3D radar distance of the pointing cursor 360. As the 3D radar distance impacts the virtual object 326 selection accuracy, in a default and recommended embodiment, the 3D radar distance value should not exceed few pixels.

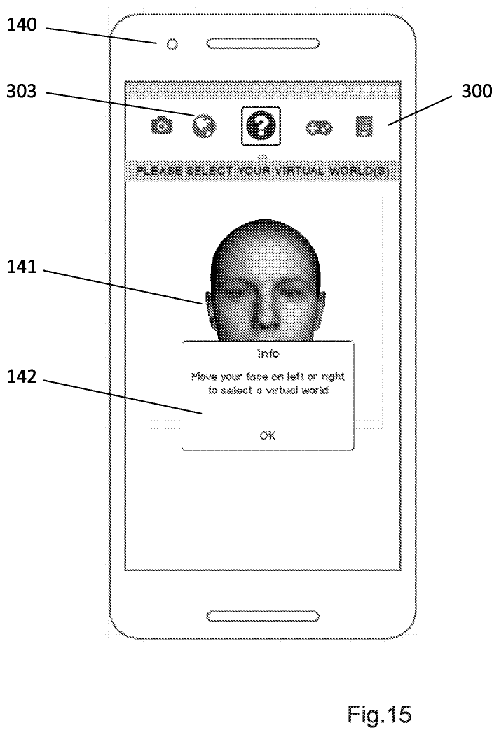

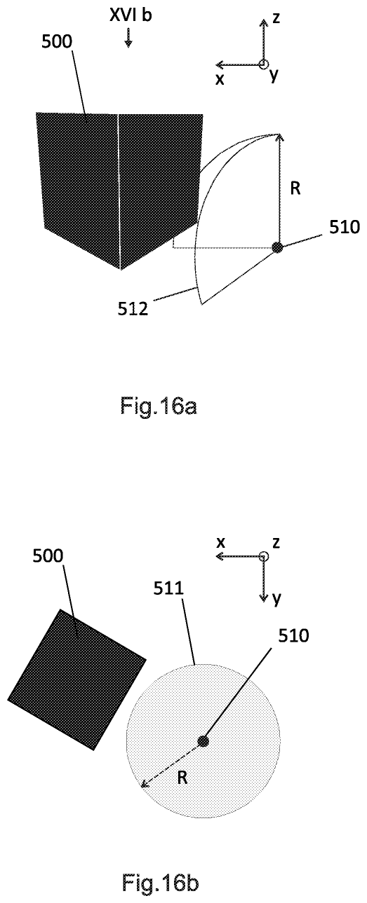

FIG. 15 illustrates the concept of the 3D radar distance to select a virtual object: FIG. 15a represents a cube object 500 that the user is wanting to select. Point 510 represents the coordinates (x, y, z) of the center of the touching point pressed on the screen by the user, from which a radar distance—the depth value in pixels from point 510—on the three dimensional axis x, y, z has been defined to determine if the user is touching—and therefore can select—the object or not. The 3D radar corresponds therefore to a volume around point 510 which allows to determine if the demi-sphere or sphere 512 around 510 is touching or not the object 500. FIG. 15b represents the same thing as in FIG. 15a, in 2D, that could be a projection of the 3D view of FIG. 15a from the top of the cube (top face on FIG. 15a), in a plane (x, y): the cube object 500 that the user is wanting to select is seen as a square and the point 510 represents the coordinates (x, y, z) of the center of the touching point pressed on the screen by the user, from which a radar distance—the depth value in pixels from point 510—on the three dimensional axis x, y, z has been defined to determine if the user is touching—and therefore can select—the object or not. The 3D radar corresponds therefore in that projection view of FIG. 16b, to a surface around point 510 which allows to determine if the circle 511 around 510 is touching or not the object 500. In the case shown on FIG. 16a (16b), the sphere 512 (circle 511) has a radius R shorter than the distance between the point 510 and the object 500 (cube in FIG. 16a, square in FIG. 16b), so that it means that the virtual object (the cube 500) is out of the 3D radar distance of the point 510. If (case not shown), the sphere 512 (circle 511) has a radius R equal to or larger than the distance between the point 510 and the object 500 (cube in FIG. 16a, square in FIG. 16b), then it means that the virtual object (the cube 500) is at (or within) the 3D radar distance of the point 510. The radius R depends among others from the type and the adjustments of the pointing cursor 360. Therefore virtual objects which are at three-dimensional radar distance of the pointing cursor mean virtual objects able to be pointed at by the pointing cursor, i.e. virtual objects which are placed at a distance equal to or less than a detection radius R (more generally at a distance equal to or less than a detection distance) from the pointing cursor 360. Such a detection radius R, or more generally a detection distance, R is known and predetermined or adjusted for each pointing cursor. In an embodiment, while selecting a virtual object 500 with the pointing cursor 360 which is at radar distance from the point of selection 510, the corresponding selected virtual object 500 changes his appearance on the display 120 (for instance through a change of color, of contrast, of light) so that the user can see which virtual object he has selected.

In case of the pointing cursor 360 is seeing plural virtual objects at the 3D radar distance, the application 180 will display all the corresponding contextual object boxes 320 of the selectable virtual objects 326 found. In a preferred embodiment, only one virtual object should be selected at a time and the user can directly click the right contextual object box 320 or can move the pointing cursor 360 to see only one selectable virtual object 326 or can change the scale of the scene view 302 by zooming-in as an example.

In another embodiment, the pointing cursor 360 can allow the user to navigate and explore the virtual world without changing the scale 302 of the scene view, and the application 180 should not allow the user to pass through the virtual object 326 for real-life similarity purposes.

To select a virtual object 326, well-known software object selection techniques are used by the application 180 such as single-tapping, double-tapping, maintaining pressure on the virtual object for a while or alike. In case of single or double-tapping action or alike, the position of the pointing cursor 360 is immediately updated in the virtual world 310. Upon stopping touching the screen, single or double-tapping or alike, in a preferred embodiment, the contextual box 320 is no more displayed. To unselect a virtual object, the same techniques can be used and the contextual box 320 can display a message confirming that the virtual object has been unselected.

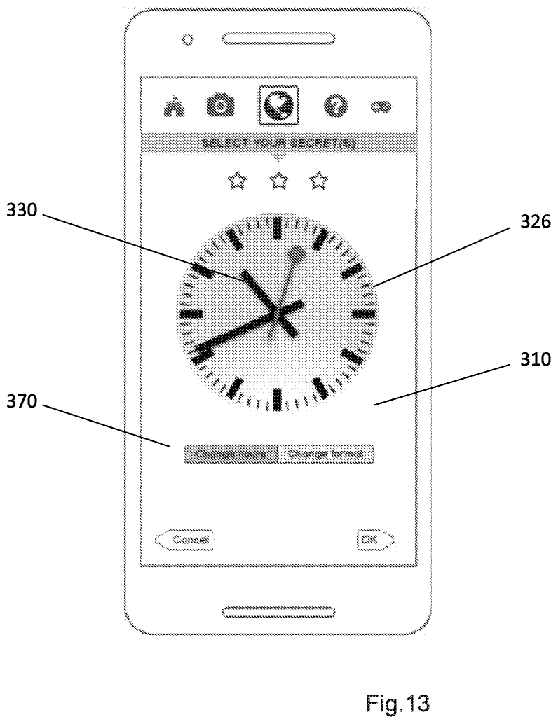

To perform one or plural actions 370 onto a selected virtual object 326, in a preferred embodiment, instead of displaying a list of applicable actions in the contextual window 320, the 3D context-sensitive teleportation mechanism can be used to teleport the user in a local scene showing the virtual object 326, where one or plural actions 370 can be applied. Referring to FIG. 13, there is illustrated a local scene that represents the big clock 326 as shown in FIGS. 7 and 11, where the user can change the hour or the format of the clock 370.

There is disclosed another novel concept called “dynamic object interaction” where the user can specify a secret interaction that must be performed accordingly to the nature of the virtual object and one or plural dynamic criteria. As an example, at enrolment, the user can define that the secret is made by selecting the big clock 326 in FIG. 7 and by performing a time change on the clock 326 in the local scene of FIG. 13, so that it always corresponds to minus 1 hour and 10 minutes. In a preferred embodiment, the time displayed on the big clock 326 at each authentication is different and the user will have to always adjust the time by moving a selected virtual item (here a hand 330) to minus 1 hour and 10 minutes relatively to the time being displayed on the big clock 326. This approach is particularly powerful as it allows to significantly reduce the attempts of shoulder surfing attacks.

In another embodiment, the digital entropy can be increased by moving a virtual item 331 to a new place in the virtual world 310, the virtual item 330 and the path taken or the final destination in the virtual world 310 constituting the secret.

Referring to FIG. 6, there is shown a selected virtual item 331 in a second scene of view where additional attributes and/or actions can be changed or applied to constitute the user's secret and increase the digital entropy. In the example of FIG. 6, virtual item 331 is a car that is made of sub-items such as the front-left wheel 332, the hood, the bumper or the roof, which sub-parts can be selected by the user to constitute the secret or a part of the user's secret. Attributes of virtual item 331 or sub-part 332 can be changed as well. In the example of FIG. 6, the colour of the virtual item 331, here the car, can be changed. To increase the number of possible combinations constituting the secret, the application can propose applicable actions to the virtual item 331. As an example, in FIG. 6, the use can switch on the headlamps in the list of possible actions. In another preferred embodiment of a virtual world using three-dimension space, the application 180 can allow the user changing the position of the selected virtual item 331 in the scene of view by changing the virtual item pitch 337, yaw 335 and/or roll 336 orientations. In that case, the three-dimensional position (x,y,z) of the selected virtual item 331 can be either represented in the original virtual world scene or in the new relative scene as shown in FIG. 6. Preferably, the application 180 can use fixed increment values for pitch 337, yaw 335 and roll 336 to void user mistakes when selecting the right orientations that are part of the virtual item secret.

In a preferred embodiment, the application 180 can apply a visual effect on the pointed virtual object 326, such as displaying an animated, semi-transparent border around the virtual object. This method helps the user to void confusing virtual objects, particularly when multiple objects look alike. As an example, in FIG. 7, the user may choose the second pedestrian crossing strip 325 or crosswalk tile 321.

The brief description or title of the contextual box 320 should ideally not contain any virtual object identifier to limit shoulder surfing attacks to the maximum possible.

3D Graphical Matching

Referring to FIGS. 2 and 3, the 3D graphical authentication method comprises the matching analysis 223 of the selected virtual objects or interactions. The matching 223 is performed by comparing unique identifiers assigned to each virtual objects or object interactions that are contained in the scene graph. Unlike graphical authentication matching methods unveiled in the prior art, the method proposed here doesn't rely on three-dimensional position analysis.

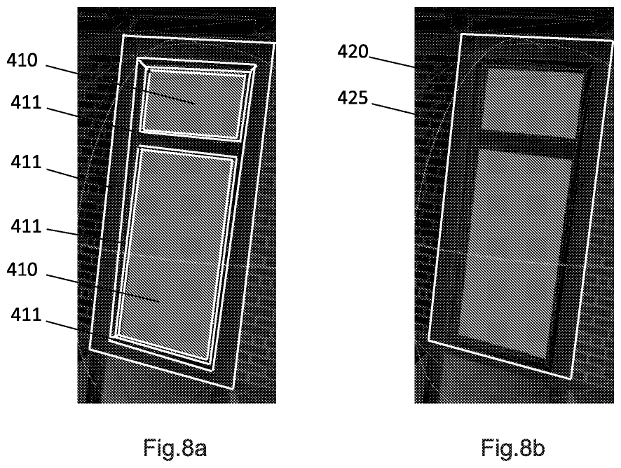

Augmenting the digital entropy and easing objects selection FIG. 8 illustrates the alleviation technique used to significantly reduce the number of polygons that constitute a 3D object. In that regard, the expression “low poly graphics” used in the present text means “alleviated poly graphics” obtained by an alleviation technique. In the same way, the expression “low poly meshes” used in the present text means “alleviated poly meshes” obtained by an alleviation technique. As an example, FIG. 8a represents a regular 3D window object made of two glass parts 410, ten window frames made of rectangle meshes 411 and three textures (glass, dark grey and light grey). In FIG. 8b, the same window object has been alleviated to the maximum and is only made of one rectangle mesh and one texture, which texture draws the window frames and the glasses with a 3D effect rendering. By reducing the number of meshes, we also limit the possibilities to select a wrong object for the user, particularly when using a mobile device like a smartphone. As an example, in FIG. 8a, the user can easily do a mistake and select the window frame 411 instead of the glass 410, resulting in a wrong object selection situation.

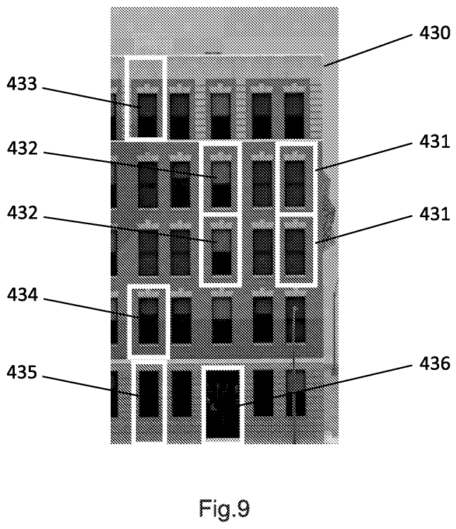

FIG. 9 illustrates another alleviation technique used for big objects—in that example building 430—which are made of sub-objects. The building façade shown here is made of 1 door pattern 436 and 24 windows patterns, each different windows pattern 431 to 435 being made of one rectangle mesh and one texture. To augment object alleviation, the window object 420 of FIG. 8b has been extended to comprise the brick wall parts around the window, the global texture containing the window 420 texture of FIG. 8b and the brick wall texture 425. The result is simplified window patterns 431 to 435 that can be instantiated multiple times on the building facades. In term of number of polygons, the whole building 430 can be designed with one door pattern 436, five different window patterns 431 to 435 and eight structure rectangles that constitute the building structure. In another technique, the simplified window pattern 431 to 435 can be made of one window object 420 as in FIG. 8b and one rectangle frame containing the brick wall texture.

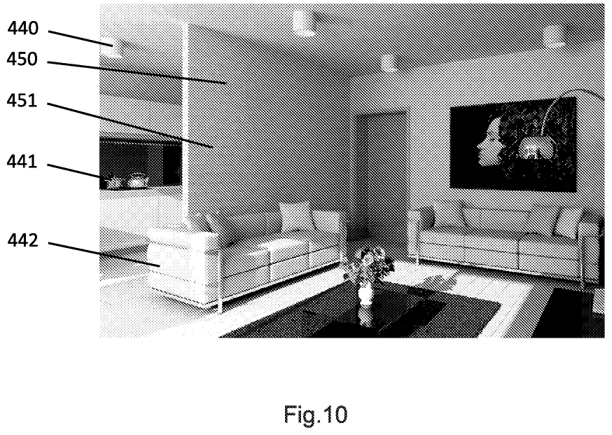

FIG. 10 illustrates one of the techniques used to increase the number of 3D graphical password combinations in the 3D virtual world. The technique consists in creating local scenes with tens or hundreds of objects that can be selected and/or that can be subject to interactions on these objects, which objects can be geometrically instantiated. Back to FIG. 9, the user can teleport himself inside the building by double-clicking on the first window from the right at the third floor as an example. In that case, the system will display a new global scene view after teleportation, which is a local scene as shown in FIG. 10 that corresponds to the flat that is located at third floor utmost right window at building 430 of FIG. 9. The local scene in FIG. 10 comprises various objects such as sofas, a table, carpets, paintings, lamps, kitchen tools, a door and other objects. As described before, the local scene can instantiate identical objects (e.g the sofa 442 or the white lamps 440 or the boiler 441) to reduce the number of meshes instantiated in the scene graph.

As mentioned before, offering object interactions is another technique to increase the digital entropy. As an example in FIG. 10, user can press the white wall 450 which will allow the user to select among a list of paintings 451. By offering tens of objects with tens of object interactions, it is therefore possible to reach one-hundred object selection/interaction combinations or more per local scene. Assuming each floor of the building can contain 10 apartments that are geometrically instantiated—and where some objects can be randomly changed to provide visual differences to the user—and that the building has 5 floors, the total number of selectable objects and object interactions can reach:
Local scene apartment: 100 combinations;
Number of apartments per floor: 10;
Number of floors: 5;
Total number of combinations for local scenes in the building: 5×10×100=5′000;
Number of objects selectable on the façade: 25×4=100;
   Number of buildings in the 3D world: 10;
   Minimum number of combinations in the 3D world: 10×5100=51′000;
   3D graphical password space:
      by selecting 1 secret->51′000 combinations,
      by selecting 2 secrets->51′000×51′000=2.6 Billion combinations (2.60 10⁹,
      by selecting 3 secrets->51′000×51′000×51′000=132,65 Trillion combinations (1.32 10¹⁴).

By using one or several of the techniques described above, we showcased how digital entropy can be maintained quite high while using a limited number of objects, meshes and textures in the scene graph and easing object selection or object interaction

Dynamic context sensitive authentication Referring to FIG. 11, there is illustrated a novel “dynamic context sensitive authentication” approach that indicates to the user the level of security that must be matched to get authenticated. Back to FIG. 2 or 3, the application 180 can determine the level of security required to get authenticated upon receiving the authentication request 210. This novel method allows to define a 3D graphical authentication process that is dynamically adapting the security level accordingly to the nature of the transaction. As an example, in a preferred embodiment, a user will be prompted to select only one virtual object or to perform only one virtual objects action forming said secret to login into a software application, whereas a mobile payment of $10′000 will require to select virtual objects and/or apply object interactions with a total of three when adding selected virtual object(s) and performed virtual objects (inter)action(s).

In another preferred embodiment, the dynamic context sensitive authentication can be implemented in a way to guarantee zero or very low false rejection rate. For example, the security threshold to perform a high-level transaction can be set to 99.99999% or 1 error out of 10 millions. In that case, the method can dynamically adapt the number of 3D graphical secrets to be entered and/or the number of biometric authentication checks until the global security score reaches 99.99999%. In a system using 3D facial biometry and 3D graphical authentication, the user might then be prompted after having entered the first graphical secret and performed a 3D facial biometry check, to enter a second graphical secret (corresponding to a second pre-defined 3D password) because the system has determined that global security score or global authentication score, including a 3D facial biometry score, was not enough. That method is particularly interesting for situations where the concurrent biometry checks result in low scores and must be compensated with additional 3D graphical secrets to reach out the minimum-security score required for the transaction. This approach can result in always guaranteeing to the right user that the transaction will be performed if it is really him.

Back to FIG. 11, there is shown an example where the security level for the transaction is maximum, where three virtual objects or interactions must be entered by the user, represented here by three stars 350, 351 and 352. The black stars 350 and 351 tells the user that two virtual objects or interactions have been already entered. The white star 352 tells the user that one remaining virtual object or interaction must be entered to complete the 3D graphical authentication 220.

In another possible embodiment, the application 180 can authorize the user to enter the virtual objects in a not-imposed order. Back to FIG. 7, as an example, if the user has defined a secret that is made of the pedestrian crossing strip 325 as first secret then the big clock 326 as a second secret, the user can tap the second white star 352 and move the pointing cursor 360 onto the big clock 326, indicating to the application 180 that the second secret has been entered. In a second step, the user can tap the first white star 351 and move the pointer cursor 360 onto the pedestrian crossing strip 325 to select the first virtual object secret.

Shoulder Surfing Attacks To overcome shoulder surfing attacks, the 3D graphical authentication method 220 discloses multiple approaches to overcome or limit any shoulder surfing attacks.

In a preferred embodiment, upon single-tapping a virtual object, a short graphical effect on the selected object or around the virtual object selected is applied, such as any blurring effect, applying a colored contour around the object in a furtive and discreet way.

In another preferred embodiment, if the electronic device 100 is haptic enabled, the application 180 can make the electronic device 100 vibrating upon selecting or unselecting virtual objects. Optionally, in case the electronic device 100 is a smartphone or tablet, the application 180 can detect if an earphone has been plugged-in and play audio messages upon navigating, selecting, unselecting virtual object or applying actions on virtual objects when entering the secret.

In another preferred embodiment, the concept of dynamic context interaction as disclosed before can help to significantly reduce shoulder surfing attacks, as it will extremely difficult and time-consuming for a fraudster to discover what is the exact rule that constitutes the interaction secret.

In another embodiment, the method allows the selection of virtual objects that look alike, such as crosswalk tiles 311 or 325, where the display of a virtual world that looks real help the user to memorize exactly the position of the virtual object secret, voiding to display specific markers or clues in the virtual world 310.

911 Secret

In another preferred embodiment, the user can define one or several secret virtual objects or actions serving as 911 emergency telephone number or emergency assistance code(s) at enrolment. Optionally, the virtual world itself may contain specific 911 virtual objects that can be made available in any scenes. At any time during a 3D graphical authentication, notably during the 3D password selection step, the user can select one or several of these 911 virtual objects, forming the emergency or 911 secret/3D password, to require emergency assistance in order to signal that he is under duress, for example because an assailant is forcing him to enter the 3D password defined during the previous enrolment phase. As an example, if the user is being hi-jacked while performing a money withdrawal to an ATM (automated teller machine), the user can select one of these 911 virtual objects, which in a preferred embodiment, will immediately block the transaction.

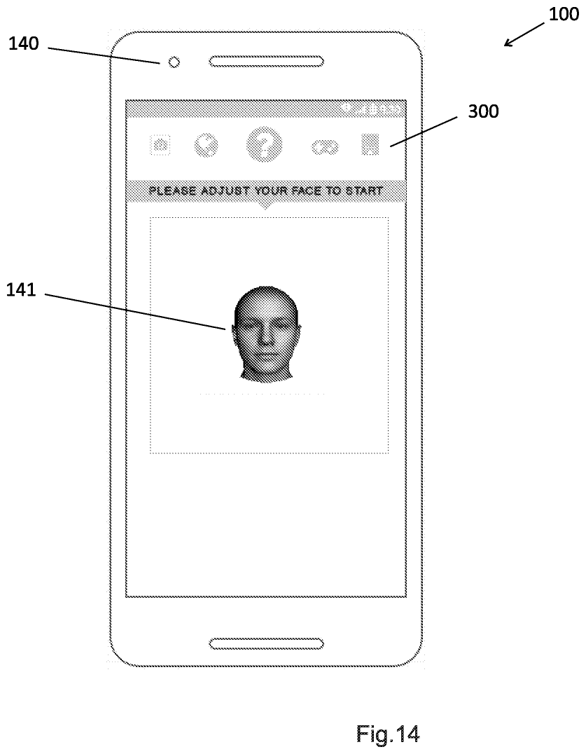

Referring to FIGS. 14 and 3, there is shown another embodiment where the application 180 has been configured to enable a two-dimensional or three-dimensional biometric authentication 230 prior or during the virtual world selection or virtual items selection 222 As an example, the user may have a smartphone equipped of a depth camera 140 and capable of 3D facial biometric authentication. Upon detecting that the user's face is too far away from the electronic device 100 and depth camera 140, the application 180 can display a message inviting the user to get closer while displaying the monochrome, RGB or depth camera output on screen 120. Upon user's face being closer, the application 180 can propose to select a virtual world 310 among the list 300 proposed. In one embodiment, the biometric authentication steps 231 and 232 can interrupt the virtual world selection steps 221, 222 and 223 if the biometric score doesn't match. In another possible embodiment, the application 180 can wait until the end of both biometric authentication 231 and virtual item secret selection 22 to reject the authentication of the user to void giving any useful information to possible fraudsters.

By extension, such concurrent authentication method can be applied to any other biometric modalities available in the electronic device 100, including but not limited to:
in-display fingerprint biometric modality where each time the user is touching the display, a fingerprint is captured 222, analysed 223 and taken into account into the final authentication step 240 or a fingerprint is captured 222, stored temporarily and fused later with one or other fingerprint captures to create one fused accurate fingerprint that will be used to match with the enrolment fingerprint.
regular fingerprint biometric modality such as Touch ID by Apple or equivalent, where each time the user is touching the fingerprint sensor, in a preferred embodiment, a fingerprint is captured 222, analysed 223 and taken into account into the final authentication step 240 or a fingerprint is captured 222, stored temporarily and fused later with one or other fingerprint captures to create one fused accurate fingerprint that will be used to match with the enrolment fingerprint.
   finger-vein or palm-vein biometric modality where each time the user is approaching a finger or palm to the vein sensor 140, in a preferred embodiment, a finger-vein or palm-vein print is captured 222, analysed 223 and taken into account into the final authentication step 240 or a finger-vein or palm-vein print is captured 222, stored temporarily and fused later with one or other finger-vein or palm-vein print captures to create one fused accurate finger-vein or palm-vein print that will be used to match with the enrolment finger-vein or palm-vein print.

Referring to FIG. 15, another possible embodiment for the application 180 is to prompt the user selecting a virtual world among the list 300 by moving head to left and/or right, the head pose being computed and used to point a selectable virtual world in list 300. As an example, the user can move his head on left to select the city virtual world icon 302 that will select the city virtual world 310 shown in FIG. 4. The user can then start selecting one or a plurality of virtual items as defined in step 212. During that time, 3D facial authentication step 220 will be processed to optimize speed and improve the user experience.

The present invention also concerns a method for securing a digital transaction with an electronic device, said transaction being implemented through a resource, comprising implementing the three-dimensional graphical authentication method previously presented or a multi-factor authentication method for verifying the identity of a user previously presented, wherein after the authentication phase, taking into consideration said comparison result for granting or rejecting the resource access to the user, in order to reply to the authentication request. As a possible implementation for providing a comparison result, implementing the following steps:
determining if the formed 3D password matches a 3D password defined at a previous enrolment phase, and
granting the resource access to the user in case of 3D password matching or rejecting the resource access to the user in case of matching failure.

The present invention also concerns a three-dimensional graphical authentication system, comprising:
an electronic device with a graphical display,
a processing unit arranged for:
   receiving an authentication request (or launching an application),
   , displaying on said display a three-dimensional virtual world containing a plurality of virtual objects or augmented reality objects by using scene graph with geometry instancing and low poly graphics,
   navigating in the three-dimensional virtual world by using a rotatable and scalable scene view of the display,
   selecting on the display one or plural virtual objects and/or performing pre-defined virtual object actions on the display to form a 3D password, the 3D password being made of unique identifiers that correspond to the pre-defined virtual objects and/or actions in the scene graph,
a memory for storing the 3D password.

The present invention also concerns a three-dimensional graphical authentication system, comprising:
an electronic device with a graphical display,
a processing unit arranged for:
   receiving an authentication request,
   , displaying on said display a three-dimensional virtual world containing a plurality of virtual objects or augmented reality objects by using scene graph with geometry instancing and low poly graphics,
   navigating in the three-dimensional virtual world by using a rotatable and scalable scene view on said display,
   selecting one or a plurality of virtual objects and/or performing virtual object actions to form a 3D password, forming thereby a formed 3D password made of unique identifiers that comprise the selected virtual objects and/or performed actions in the scene graph
a memory for storing the formed 3D password.

In of the previously defined dimensional graphical authentication systems, according to a possible provision, said processing unit is also arranged for:
determining if the formed 3D password matches a 3D password defined at a previous enrolment phase, and granting the resource access to the user in case of 3D password matching or rejecting the resource access to the user in case of matching failure;

### Or

comparing said formed 3D password to a pre-defined 3D password, and providing a comparison result (this comparison result being generally YES or NO, “0” or “1”).

The present invention also concerns a computer program product comprising a computer readable medium comprising instructions executable to carry out the steps of any one of the methods claimed or defined in the present text.

The present invention also concerns an electronic device, such as a mobile equipment, comprising a display and comprising a processing module, and an electronic memory storing a program for causing said processing module to perform any of the method claimed or defined in the present text. In a possible embodiment, said processing unit is equipped with a Trusted Execution Environment and a Rich Execution Environment.

Thanks to at least some of the possible embodiments of the invention described above, are proposed some solutions to deliver higher memory recall, and/or to provide a 911 assistance mechanism, and/or to give a personalized experience at user enrolment and authentication, and/or to provide a context-sensitive authentication method, and/or to use one or a plurality of biometric modalities to increase the digital entropy.

According to some of the possible embodiments of the present invention, it can be proposed a method and/or a system that tells how to manage thousands or more of virtual objects in the 3D virtual world, which solution is not presented in the prior art.

### LIST OF REFERENCE SIGNS USED IN THE FIGS

100 Electronic device
101 Central Processor Unit (CPU)
102 Graphical Processor Unit (GPU)
103 Neural Network Processor Unit (NPU)
110 Random Access Memory (RAM)
111 Non-Volatile Memory (ROM)
120 Display
130 Controls (volume, . . . )
140 Sensors (fingerprint reader, depth camera . . . )
141 Camera display
142 Popup message
150 Transceivers
180 Software application
190 Secure enclave (Trusted Execution Environment . . . )
200 Global authentication method
210 Authentication request or launching application login module
220 3D graphical authentication method
221 Display of selectable virtual worlds or sub-worlds module
222 Virtual object(s) selection or interaction module
223 Comparison and match checking module
230 Biometric authentication method
231 (Multi-)biometric authentication activation module
232 (Multi-)biometric authentication matching module
240 Global authentication analysis module
300 List of selectable virtual worlds
302 Scene view scale
303 Selectable city virtual world
305 Destination areas shortcut(s)
310 Display of the selected world and sub-world
311 Teleport destination(s)
320 Contextual object box
321 Virtual object (crosswalk tile)
325 Virtual object (second pedestrian crossing strip)
326 Virtual object (big clock)
330 A selected virtual item (hand)
331 A selected virtual item (car)
332 A selected sub-item (wheel)
335 Virtual item yaw orientation
336 Virtual item roll orientation
337 Virtual item pitch orientation
350 Star
351 Star
352 Star
360 Pointing cursor
370 Virtual object actions(s)
410 Glass parts
411 Window frame
420 Window object
425 Brick wall texture
430 Building
431 Window pattern
432 Window pattern
433 Window pattern
434 Window pattern
435 Window pattern
436 Door pattern
440 White lamp
441 Boiler
442 Sofa
450 White wall
451 Painting
500 Object
510 Point
511 Circle
512 Sphere

1. A three-dimensional graphical authentication method for verifying the identity of a user through an electronic device having a graphical display, comprising the steps of:
receiving an authentication request or launching an application,
displaying a three-dimensional virtual world containing a plurality of virtual objects or augmented reality objects by using scene graph with geometry instancing and low poly graphics,
navigating in the three-dimensional virtual world by using a rotatable and scalable scene view,
selecting one or plural virtual object(s) and/or performing pre-defined one or plural virtual object action(s) to form a 3D password, the 3D password being made of unique identifiers that correspond to the pre-defined virtual object(s) and/or action(s) in the scene graph,
determining if the formed 3D password matches a 3D password defined at a previous enrolment phase; and
granting the resource access to the user in case of 3D password matching or rejecting the resource access to the user in case of matching failure.

2. The three-dimensional graphical authentication method of claim 1, wherein the user can navigate in the said three-dimensional virtual world by using 3D context sensitive teleportation, the teleportation destinations being preferably context sensitive on the current scene view and scale

3. The three-dimensional graphical authentication method of claim 2, wherein the said teleportation destination can be a pre-defined position or destination in the selected virtual world or in another virtual world.

4. The three-dimensional graphical authentication method of claim 2, wherein each selected virtual object or sub-part of the selected virtual object teleports the user in a local scene representing the selected virtual object or sub-part of the selected virtual object, or in a local scene with an inside view of the selected virtual object.

5. The three-dimensional graphical authentication method of claim 1, wherein during said selection step, the user performs 3D contextual object selection, comprising using a pointing cursor, displayed or not in the scene, that allows to select virtual objects which are at three-dimensional radar distance of the said pointing cursor.

6. The three-dimensional graphical authentication method of claim 5, wherein during said selection step, said pointing cursor is moved in the scene view or is placed onto a teleportation destination marker or on a virtual object that offers teleporting capabilities to navigate in the virtual world or get teleported to the selected destination.

7. The three-dmensional graphical authentication method of claim 5, wherein during said selection step the user applies a pre-defined action on a virtual object, said action representing said 3D password or part of said 3D password.

8. The three-dimensional graphical authentication method of claim 7, wherein said virtual object action is selected into a displayed list of possible actions into a contextual window or into a separate window or said virtual object action teleports the user in a local scene representing said selected virtual object or sub-part of the selected virtual object, or in a local scene with an inside view of the selected virtual object.

9. The three-dimensional graphical authentication method of claim 7, wherein said virtual object action is dynamic, requiring the user to take into account one or several dynamic criteria to specify said virtual object action.

10. The three-dimensional graphical authentication method of claim 1, wherein said 3D password matching determination step is performed by using one or a plurality of unique identifiers corresponding to the virtual objects and/or actions performed on these objects, the matching being performed by comparing identifiers used at enrolment and at authentication.

11. The three-dimensional graphical authentication method of claim 1, wherein, previous to the step of displaying a three-dimensional virtual world, a plurality of selectable virtual worlds is first proposed to the user who makes a selection of one three-dimensional virtual world among these selectable three-dimensional virtual worlds.

12. The three-dimensional graphical AR authentication method of claim 1, wherein said method further dynamically determines the level of security required to get authentication accordingly to the nature of the transaction, the security level being represented graphically on the display of the electronic device and indicating to the user how many virtual object(s) and/or virtual objects action(s) are required during the selection step, forming thereby a context sensitive authentication method.

13. The three-dimensional graphical authentication method of claim 1, wherein during the selection step, a selection order is attached to each selected virtual object and each virtual object action.

14. The three-dimensional graphical authentication method of claim 1, wherein it further comprises an emergency or assistance signalling procedure that comprises the selection of at least one 911 virtual object and/or the implementation of at least one pre-defined emergency action on a virtual object, said procedure being performed at any time during the selection step.

15. The three-dimensional graphical authentication method of claim 1, further comprising one or several biometric authentication control(s), each biometric authentication control being performed concurrently to said 3D graphical authentication method, forming thereby a multi-factor authentication method.

16. A three-dimensional graphical authentication system, comprising:
an electronic device with a graphical display,
a processing unit arranged for:
receiving an authentication request or launching an application,
displaying on said display a three-dimensional virtual world containing a plurality of virtual objects or augmented reality objects by using scene graph with geometry instancing and low poly graphics,
navigating in the three-dimensional virtual world by using a rotatable and scalable scene view of the display,
selecting on the display one or plural virtual object(s) and/or performing pre-defined one or plural virtual object action(s) on the display to form a 3D password, the 3D password being made of unique identifiers that correspond to the pre-defined virtual object(s) and/or action(s) in the scene graph,
a memory for storing the 3D password.

17. A three-dimensional graphical authentication method for verifying the identity of a user, comprising the steps of:
providing an electronic device, said electronic device having a 2D graphical display equipped with a touch screen and/or pointing system providing a pointing cursor,
receiving an authentication request starting an authentication phase,
displaying on said 2D graphical display a three-dimensional virtual world containing a plurality from virtual objects and augmented reality objects by using scene graph with geometry instancing and low poly graphics,
navigating in the three-dimensional virtual world by using a rotatable and scalable scene view on said display through the user touching said touch screen and/or manipulating said pointing cursor,
selecting at least one operation from selecting one or a plurality of virtual objects through the user touching said touch screen and/or manipulating said pointing cursor and performing one or a plurality of virtual object actions through the user touching said touch screen and/or manipulating said pointing cursor, forming thereby a formed 3D password made of unique identifiers that comprise at least one from selected virtual object(s) and performed action(s) in the scene graph,
comparing said formed 3D password to a pre-defined 3D password; and
providing a comparison result.

18. The method of claim 17, wherein before receiving an authentication request, implementing an enrolment phase in which said pre-defined 3D password is defined through a selection step comprising at least one operation from selection of at least one virtual object and performing at least one virtual object action in the scene graph, said selection step forming thereby said pre-defined 3D password made of unique identifiers.

19. The method of claim 17, wherein during said comparison step, determining if the formed 3D password matches said pre-defined 3D password by using said one or said plurality of unique identifiers corresponding to the selected operation(s), and by comparing each identifier used at enrolment phase and at authentication phase.

20. A method for securing a digital transaction with an electronic device, said transaction being implemented through a resource, comprising implementing the three-dimensional graphical authentication method according to claim 17, wherein after the authentication phase, taking into consideration said comparison result for granting or rejecting the resource access to the user, in order to reply to the authentication request.
